(19) United States
(12) Patent Application Publication
(10) Pub. No.: US 2023/0156171 A1
(43) Pub. Date: May 18, 2023

(54) A METHOD FOR PROVIDING A HOLOGRAPHIC EXPERIENCE FROM A 3D MOVIE

(71) Applicant: REALFICTION APS, Copenhagen K (DK)

(72) Inventor: Steen Svendstorp KRENER-IVERSEN, Copenhagen K (DK)

(21) Appl. No.: 17/920,511

(22) PCT Filed: Apr. 21, 2021
(86) PCT No.: PCT/EP2021/060416

§ 371 Date: Oct. 21, 2022

(30) Foreign Application Priority Data
Apr. 21, 2020 (EP) 20170622.3

(51) Int. Cl. H04N 13/117; H04N 13/383; H04N 13/398; H04N 13/368

(52) U.S. Cl. CPC H04N 13/117; H04N 13/368; H04N 13/383; H04N 13/398

(57) ABSTRACT

The present invention relates to a method for micro movement perspective correction for a 3D display system. The method comprises providing the 3D display system including a display screen for displaying a 3D image to an observer observing said 3D image from an observation angle, where the observation angle is defined as an angle between the line of sight between an eye of said observer and a point at said display screen. The 3D image is generated from a data file having a 3D scene representation including an original camera angle for displaying a right eye image and left eye image. A controller and a tracking system is provided for tracking the position of said observer and determining a change in observation angle. A first offset 3D image and a second offset 3D image is synthesized from the data file and as a function of the change in the observation angle, such that the original camera angle is perceived by said observer as rotated to a first and second synthetic camera angle, and generating a 3D image and displaying it on the display screen.

### DESCRIPTION

A 3D movie is usually created by recording a left eye perspective and a right eye perspective view.

When a user watches the 3D movie, the left eye perspective view is directed to the user’s left eye and the right eye perspective view is directed to the user’s right eye. This can be controlled for example by wearing special 3D glasses that filter out relevant images or using a display with directional pixels that emits different images towards the user’s left eye and the user’s right eye.

This way, the user experiences stereoscopic 3D. A problem is that when the user moves his head, the left end right eye perspective images remain the same, unlike what would happen in the real world, where the user experiences a perspective change, which is very noticeable, even at very small head movements. This gives the impression that the “the whole world” always turn towards you so you experience it from the same perspective. This is a quite distracting artefact and is often mentioned as one of the main reasons that a significant fraction of the population audience complains about discomfort, even head ache and nausea when watching 3D movies. Another problem is that an estimated 5-10% of a population may have some level of impaired stereo vision and some may not be able to see stereoscopic depth all, instead relying on other depth cues such as micro movement parallax change sensed with a dominant eye to perceive depth and therefore they may not benefit at all from watching a movie in traditional stereoscopic 3D compared to watching it in 2D.

A light field display can deliver “look around” capability, so perspective changes when a user moves his head. For example the Dimenco “Simulated Reality” one-viewer autostereoscopic display (www.dimenco.eu) comprises an eye tracking system which can control a real-time computer graphics renderer to render a virtual scene as recorded from continuously updated camera positions, so perspectives match the corresponding positions of the users eyes. But this works with a real-time rendered virtual scene, not with a recorded 3D movie.

Instead of rendering perspective views of a virtual scene, interpolated view-synthesizing could potentially be used. I.e. perspective views could be synthetically estimated and generated from the two perspective views comprised in a 3D movie, using advanced interpolation techniques. Such techniques are well known and may comprise estimating a depth map from the two perspective views, using one or both of the perspective views together with the depth map and algorithms for estimating “hidden surfaces” to synthesize a third perspective view corresponding to a user’s eye position. Great advancements have been achieved recently in such techniques, several of them benefitting from AI techniques such as convolutional neural networks. However, there are several problems involved in implementing such a principle.

A first problem is that for several reasons we do not want the user to freely choose between a wide range of perspective view of the movie. One reason is that view-synthesizing techniques only work well when the synthesized perspectives are relatively close to one of the original perspectives, i.e. to one of the perspective views in the 3D movie. Another reason is that (except for in the so-called “VR movies” - a very small niche in film making) it is an important aspect of storytelling in a movie, including in a 3D movie, that the director, not the user, chooses the viewing angle.

A second problem arises in situations with more than one viewer.

The above object and advantages together with numerous other objects and advantages, which will be evident from the description of the present invention, are according to a first aspect of the present invention obtained by:
A method for micro movement perspective correction for a 3D display system, comprising:
A method for a display system for updating a perspective view of a first set of images, comprising:
   providing said display system including a display screen for displaying said first set of images to said observer observing said display from an observation angle,
   providing data including said first set of images or a set of 3D models for rendering said first set of images,
   said first set of images depicting a scene from a first perspective,
   providing a controller and a tracking system for tracking or detecting an eye position of said observer,
   determining said observation angle by means of said controller and tracking system,
   generating and displaying a second set of images including a first offset image as a function of said observation angle when said observer moves, each respective image of said second set of images depicting said scene from a respective perspective, each of said respective perspectives having an offset constituting an angle with respect to said first perspective,
   reducing said offset as a function of time such that a respective perspective is moved closer to said first perspective with time, or
   setting said offset to zero at the time of a scene change.

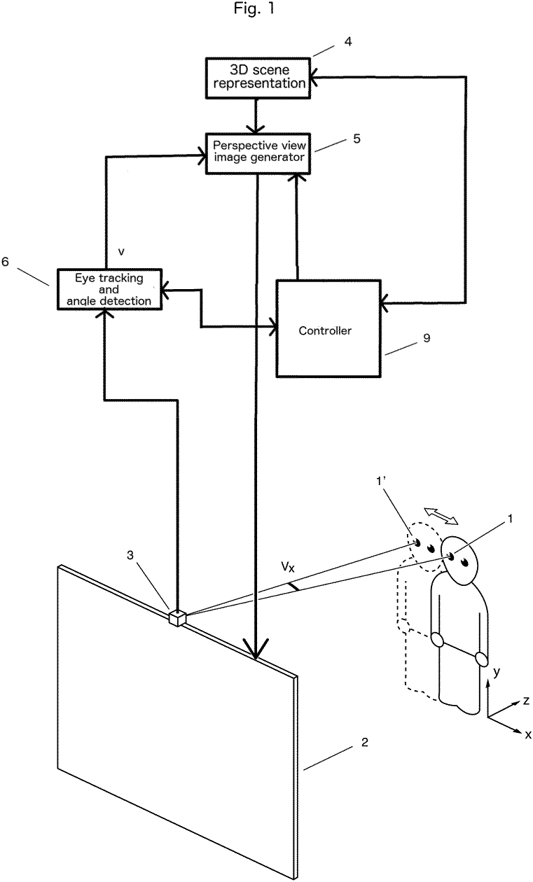

FIG. 1 illustrates an example of a display system.

An eye 1 observes a display 2.

A detector/tracking system 3 is capable of detecting the eye (or other body part of the observer) 1 and calculating an observation angle V.

A 3D content representation 4 of a scene is provided, which may comprise a representation of 3D content. This may be a 3D movie having a series of left and right eye images. The images in the content/data depicts the scenes of the movie from an intended camera angle /perspective, i.e. the perspective which the director of the movie has preferred or intended a respective scene to be viewed from.

A perspective view image generator 5 is capable of receiving the 3D content representation 4 and the observation angle V, which may be composed of a horizontal component Vx′ and a vertical component Vy′ and the perspective view image generator 5 is capable of calculating and outputting to the display 2 a perspective image, i.e. an image depicting the scene from a perspective different than the intended perspective (the perspective defined by the content of the data) - thus the generated image will have a perspective with an offset/angle compared to the original image. Both a left eye image and a right eye image may be generated and displayed to a left and right eye of the observer for 3D effect.

Thus, the image will follow the observer when the observer moves thereby creating a holographic effect.

The observation angle V may be defined by having a horizontal component Vx calculated as an angle between a vertical plane and a line through the eye 1 and a point on the display and by having a vertical component Vy calculated as an angle between a horizontal plane and a line through the eye 1 and said point. Said point may be a centre of the display 2.

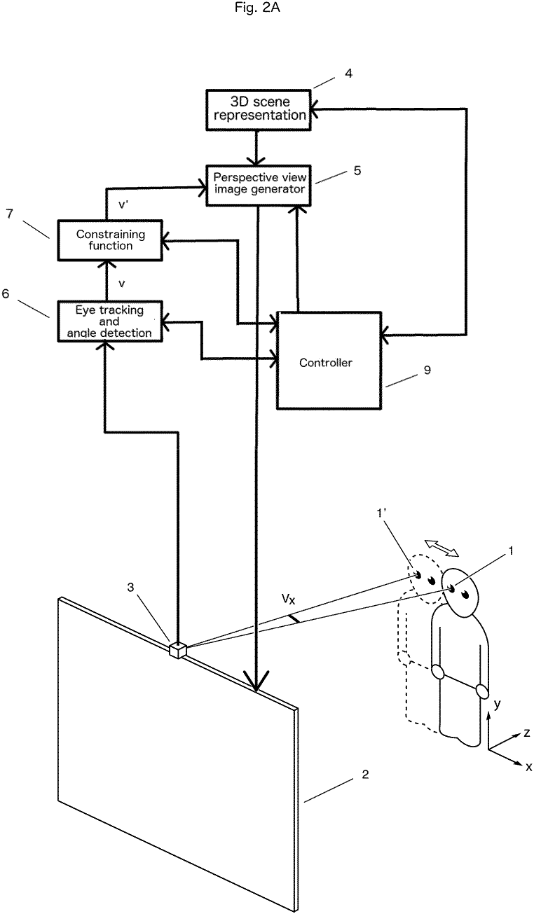

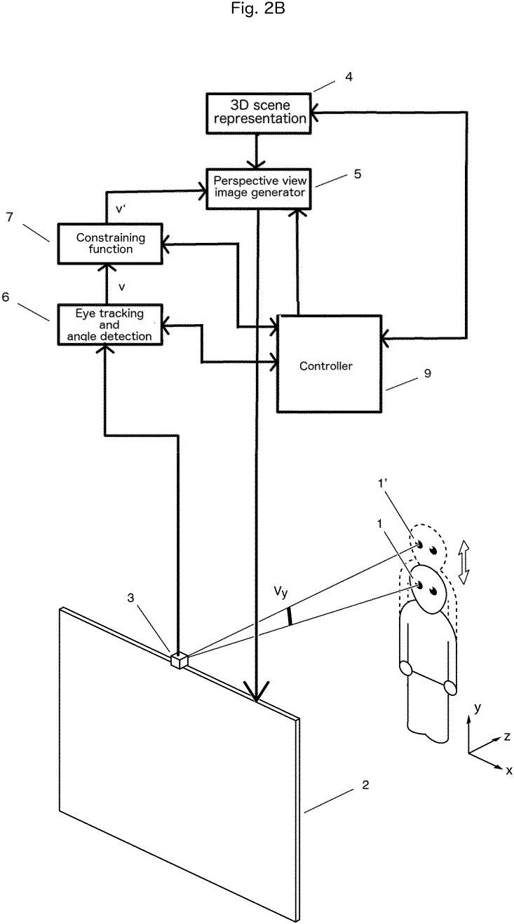

FIG. 2A shows an example of a configuration of the disclosed invention where the eye 1 is moving in a horizontal direction.

A constraining function 7 may be comprised. The constraining function 7 may constrain in an input angle V in the time domain and in the spatial domain,. i.e. it may constrain an output angle so it can only deviate from zero during a time window after a change in the input and it may constrain an output angle so it can only deviate from zero within a limited range of angles.

The constraining function 7 may receive from the eye tracking and detection subsystem 6 a representation of the observation angle V, perform a high pass filtering of V and output a resulting filtered angle V′ to the perspective view image generator 5.

The high pass filter filters away low frequency content and passes high frequency content, i.e. slow movement of the observer may not result in images generated having an offset perspective, but fast movement of the observer may result in images generated having an offset perspective. Instead of a high pass filter, an algorithm stored as instructions in the memory of the display may be used.

The constraining function 7 may perform a high pass filtering on a horizontal component Vx and a high pass filtering on a vertical component Vy.

A time constant T of the high pass filter may be defined as the half-time divided by 0.69, where the half time is an interval from when a step function is input to the high pass filter until the output value has decayed to half of the initial response.

The time constant T of the high pass filter may be in the range 2-15 seconds such as 3 to 10 seconds such as 4 to 8 seconds such as 5 seconds.

Alternatively, the time constant of the high pass filter may be user adjustable.

Further, the time constant T may be dynamically updated based upon image content.

For example, the time constant may be reduced in scenes where camera motion is detected and the reduction of the time constant may depend on the amount and/or character of camera motion.

FIG. 2b shows an example of a configuration similar to FIG. 2A where the eye 1 is moving in a vertical direction.

The eye 1 may be a left or a right eye of a person observing a stereoscopic image on the display 2 and the display 2 may be a stereoscopic display or part of a stereoscopic display system.

An eye opening of a pair of 3D glasses (not shown) may be located between the eye 1 and the display 2. Alternatively, the display 2 may have autostereoscopic capability. Alternatively, the display 2 may be comprised in a head mounted display system. In yet an alternative configuration the eye 1 may be an eye, for example a dominant eye, of a person with impaired stereo vision and the display 2 may be a monoscopic display.

A detector 3 may be comprised and may be located in a position fixed to the display 2. The detector 3 may for example be a camera operating in the visible or infrared spectrum. The detector 3 may further comprise a passive infrared detector.

The 3D content representation 4 may for example comprise a virtual 3D model stored in a computer memory. The virtual 3D model may be stored using for example the commercial Unity or Unreal formats or other standard or custom virtual 3D model formats as is well known in the computer game industry. Alternatively or additionally, the 3D content representation 4 may comprise a number of included perspective view images of a 3D scene. For example, the 3D content representation 4 may comprise a left eye perspective view image and a right eye perspective view image of a scene or an object, as is well known in the 3D movie industry. Alternatively or additionally, the 3D content representation 4 may be provided in formats known in the art of light field displays, for example the JPEG Pleno format. Alternatively, the 3D content representation 4 may comprise a representation of a 3D movie or part of a 3D movie for example in the format of a sequence of left eye perspective images and a sequence of right eye perspective images. Alternatively, the 3D movie may be in a format which has been prepared for fast rendering of additional perspective view images, for example the format may be a multi plane image sequence as described in referenced paper below. The 3D content representation may be a storage medium comprising a full 3D movie or it may for example be a video streaming buffer.

The perspective corrected image may be essentially equal to an original perspective view image modified so the observed 3D scene is rotated by the rotation angle V″ around a rotation centre in the 3D scene.

The original perspective view image may be defined as an image captured by a virtual camera comprised in the 3D content representation 4. Alternatively, the original perspective view image may be defined as one of a number of included perspective view images in the 3D content representation 4.

For example, if the eye 1 is a left eye of a person, the original perspective view image may be defined as a left eye perspective view image comprised in the 3D content representation 4, and if the eye 1 is a right eye of a person, the original perspective view image may be defined as a right eye perspective view image comprised in the 3D content representation 4.

The rotation centre may for example be located in a position in the 3D scene corresponding to essentially the horizontal middle of the original perspective view image and which is far away from the observation point corresponding to the original perspective view image, for example in the horizon.

The perspective view image generator 5 may comprise a circuit capable of calculating a view synthesis using at least one of the included perspective view images as input. For example, it may include a processor executing an view synthesis algorithm. The view synthesis algorithm may for example be similar to the algorithm described in the paper “Stereo Magnification: Learning view synthesis using multiplane images” by Zhou at al., University of California, Berkeley, May 2018, ACM Trans. Graph., Vol. 37, No. 4, Article 65. Publication date: August 2018. (This paper is hereby included by reference).

A set of multiplane images each corresponding to an image in an image sequence constituting a movie may be pre-calculated and perspective views may be calculated from the multiplane images during presentation. Alternatively or additionally, a calculation of a synthesized 3D scene may be performed using as input at least one of the included perspective view images and further it may comprise a perspective rendering of the synthesized 3D scene. The perspective view image generator may comprise a deep learning neural network, for example a convolutional neural network, such as for example described in the paper “DeepStereo: Learning to Predict New Views from the World’s Imagery”, Flynn et al., presented on IEEE Xplore, Las Vegas, 2016.

A controller 9 may be comprised. The controller 9 may be capable of reading the 3D content representation and update the time constant T in the high pass filter with a value calculated from or directly input from the 3D content representation 4.

A video sequence may be stored in the 3D content representation 4 and a corresponding table with a set of time code intervals with a corresponding set of time constants may be provided and stored in the controller 9. The table may be stored in the 3D content representation 4 and read by the controller 9 or it may be calculated by the controller 9 from the video sequence. The controller 9 may further be connected to the perspective view image generator 5 and direct the perspective view image generator 5 to play back a video sequence, i.e. output a sequence of video frames to the display 2 and synchronously output the set time constants in the table to the high pass filter 7.

Thereby the controller may during playback of a video sequence update the time constant T to optimize the experience. For example T may be reduced to 3 seconds in scenes with moderate camera motion and T may be reduced to 1 second in scenes with rapid camera motion. Further, the controller may reduce the time constant to substantially zero, when a scene cut is detected in the image content. Such reduction of the time constant to substantially zero may have the effect that V′ and hence V″ is quickly set to zero and hence the displayed image abruptly reverts to an original perspective image with the advantage that the abrupt change is unnoticeable because it happens synchronously with the scene cut. An advantage of this configuration where the controller updates the time constant T of the high pass filter with optimized time constants for specific intervals of a 3D movie may in many situations reduce the time where an synthesized perspective view is observed until an original perspective view is again observed.

The controller 9 may comprise software for performing automatic camera motion detection and scene cut detection substantially in real-time during playback. The software may look at a present video frame and compare it to previous frames. Additionally it may look at subsequent video frames in the 3D content representation 4.

Alternatively camera motion detection and scene cut detection may be performed before playback and may be provided as metadata at playback time together with means for synchronisation with a video frame sequence, for example as time coded meta data, which may be comprised in a video stream or provided separately.

Camera motion detection and scene cut detection may be performed automatically using camera motion detection algorithms for example comprising optical flow analysis and shot transition detection, for example using algorithms known from the technical fields of video compression and automated scene indexing. Alternatively camera motion detection and scene cut detection may be performed by a video operator who may enter the information into a meta data file, for example a table of time code intervals with a corresponding set of time constants. Or it may be performed as a combination of automatic detection and manual quality control and correction of the output of an automatic detection system.

Further, the constraining function 7 may comprise a limiter, limiting the output V′. The limiter may limit a horizontal component Vx to be between a minimum horizontal value Vx,min and a maximum horizontal value Vx, max and limit a vertical component Vy to be between a minimum vertical value Vy,min and a maximum vertical value Vy,max. Alternatively, the limiter may limit the composite total angle V to be within a minimum angle Vmin and a maximum angle Vmax. The limiter may be symmetrical, i.e. (Vx,min = -Vx,max and Vy,min = -Vy,max) or (Vmin = -Vmax). (Vx,min, Vx,max, Vy,min and Vy,max) or (Vmin and Vmax) may be selected so the output of the limiter is essentially always within a range of angles within which the perspective view image generator 5 can calculate a perspective corrected image of an acceptable image quality within an desired time interval. The limiter may comprise a sigmoid or a tanh function. The limiter 8 may comprise a hysteresis function.

Hence, when the eye 1 is moved so the change in the observation angle V is within the limits defined by angles Vx,min, Vx,max, Vy,min and Vy,max the image observed is initially perspective corrected, resulting in a natural and realistic experience, especially in the case where the display 2 is a stereoscopic display. During a subsequent time window Twin, a “fall back period” the high pass filter will reduce V′ slowly towards essentially 0 degrees. This will be experienced as a slow change of viewing angle back towards the original viewing angle, which the film director or game producer intended. Such a slow and small change of viewing angle may in most cases be experienced as a slight camera movement, or if the camera is already moving, as an ever so slightly changed camera movement, hence not be distracting to the experience, if the time constant of the low pass filter is adjusted appropriately. When the angle V′ is below a threshold angle Vt, it may be set to zero before it inputs to the perspective view image generator 5. Vt may be for example ⅒th of a degree. V′ being below Vt may be described as the eye 1 being at rest. Hence, when the eye 1 is at rest, it may see the original perspective view image.

Alternatively the constraining function 7 may comprise a smoothing operation and a difference operation, where the smoothing operation takes as input V and the difference operation takes as input the output from the low pass filter and V, and where the difference operation outputs V′.

The smoothing operation may be constructed or selected so it has a step response in which the output in a time window Twin goes gradually from substantially zero to substantially an input value of the smoothing operation and having a low gradient at the beginning of the time window Twin and a low gradient at the end of the time window Twin and a higher gradient in between the beginning and the end of the time window Twin. In other words the step response may have an ease-in characteristic and an ease-out characteristic. For example, the step response may be approximately similar to a “smoothstep function”, a “smootherstep function”, a Sigmoid function, a Tanh function or an Arctan function. The smoothing oepration may for example have a transfer function substantially being a derivative of a Sigmoid function, of a Smoothstep function, of a Smootherstep function, of the Tanh function or of the Arctan function. The ease-in and ease-out characteristics of such functions may further help to reduce noticeable change of viewing angle during the “fallback period”.

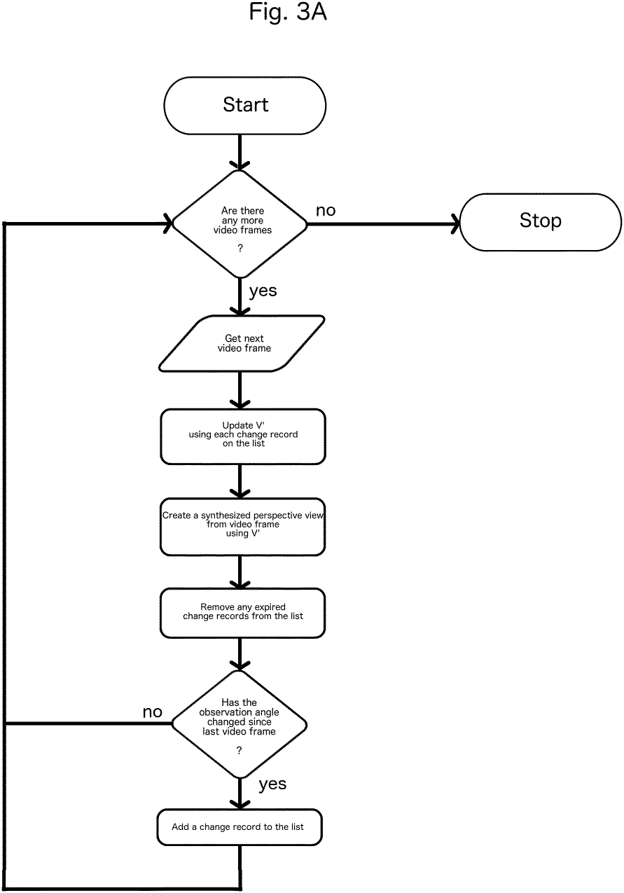

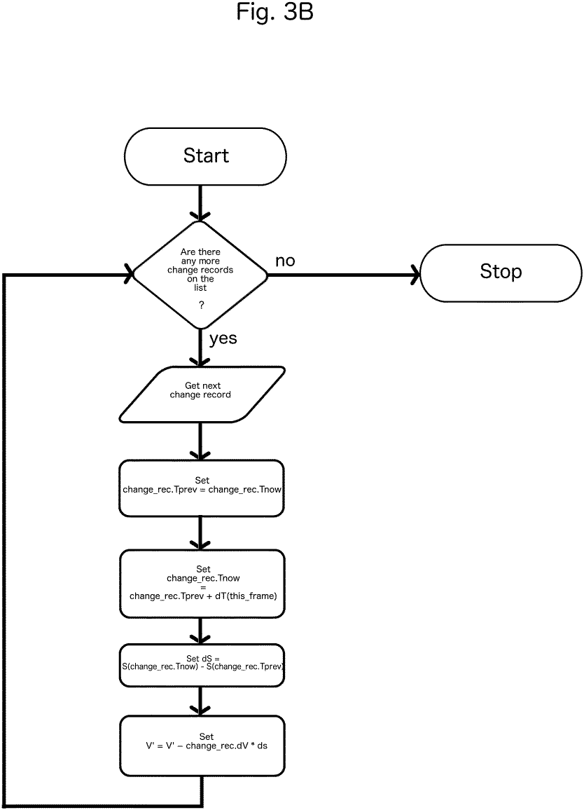

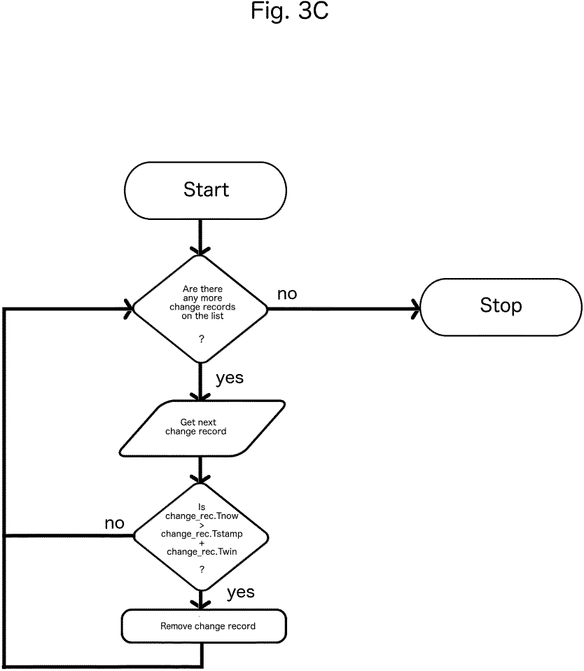

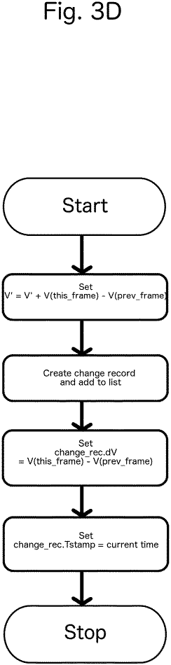

FIG. 3A shows a flow chart teaching an example of a configuration where the change response filter 10 is implemented as discrete time operations, for example as a software code executed on a processor.

In this configuration, a sequence of steps may be repeated with substantially equal intervals, for example the sequence of steps may be repeated for each image (video frame) in a sequence of images being displayed on the display 2.

The principle is, that for every video frame, it is detected via an input from the eye tracking and angle detection subsystem 6 if there has been a change in observation angle since last video frame, and if yes, a change record is added to a list, where the change record is specifying the amount of change in the horizontal and/or vertical direction (Vx and/or Vy) together with a time stamp of the change. (These operations are indicated in the bottom two boxes in the flow chart).

Further, for every video frame, the output V′ of the change response filter 10 is updated using data in the change records on the list and using the smoothing operation.

And further, for every video frame it may be detected if any change records have expired, i.e. if the current time has passed the time stamp in the change records plus the time window Twin.

FIG. 3B shows a flow chart detailing the operation labelled “Update V′ using each change record on the list” in FIG. 3A.

Each record may store a “now time” Tnow, indicating the time of the current video frame and a “previous time” Tprev, indicating the time of the previous video frame. For each record on the list this operation may update Tnow with a time increment dT. The time increment dT may be calculated as 1/(Twin * frame rate) where Twin is measured in seconds and where frame rate is the number of video frames per second. Additionally the operation may update a prev time Tprev with a value of Tnow before dT is added. Further, the operation may calculate a change in dS from Tprev to Tnow in a smoothing function having it’s output between 0 and 1, for example the Smoothstep function S(x) = 3x² + 2x³ for 0<=x<=1, whereS(x) may be set to zero when x>1. For example dS may be calculated as dS = S(Tnow/Twin) - S(Tprev/Twin) = 3*(Tnow/Twin)² + 2*(Tnow/Twin)³ - (3*(Tprev/Twin)² + 2*(Tprev/Twin)³). Further, the operation may calculate an updated value of the output V′ of the constraining function 7 by subtracting an angle change value dV stored in the change record multiplied by dS from the output value V′, so V′ = V′ - dV * Ds. As described above the time window Twin may be changed by the controller 9 to a very small value, for example a duration of a video frame, i.e. Twin = 1s/frame rate, when a scene cut is detected. Hence the effect on V′ of all angle changes stored in the change records may be essentially cancelled completely and V′ may be set to zero within the duration of one video frame and all change records may expire. This way there will be an abrupt jump back to the preferred perspective view which may be unperceptible, because it coincides with a scene change.

FIG. 3C shows a flow chart detailing the operation labelled “Remove any expired change records from the list”.

Here the principle is, that records where the current time Tnow has exceeded the time stamp Tstamp of the change plus the time window Twin are removed from the list. These change records no longer have any effect and may be removed to save memory.

FIG. 3C shows a flow chart detailing the operation labelled “Add a change record to the list”. This operation initially adds a detected change in angle from the previous video frame to this video frame to the output V′ of the constraining filter 7. Then it adds a change record to the list and stores a value dV in the change record equal to the detected change and further stores a time stamp Tstamp of the current time. Hence a change record is created storing information about an angle change amount with a time stamp of when it happened and this records is added to the list.

All angle values and angle change values in FIGS. 3A - 3C may be stored and processed in both the horizontal and vertical direction, for example V may indicate a vector value Vx,Vy.

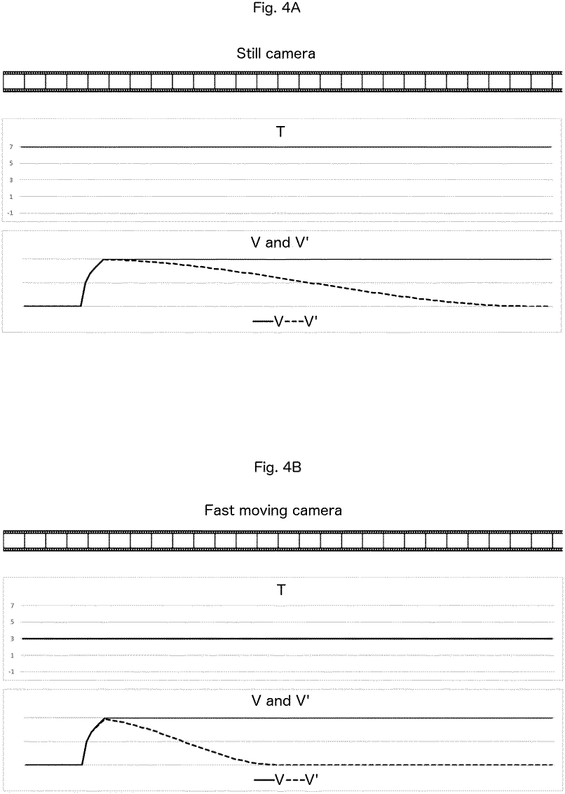

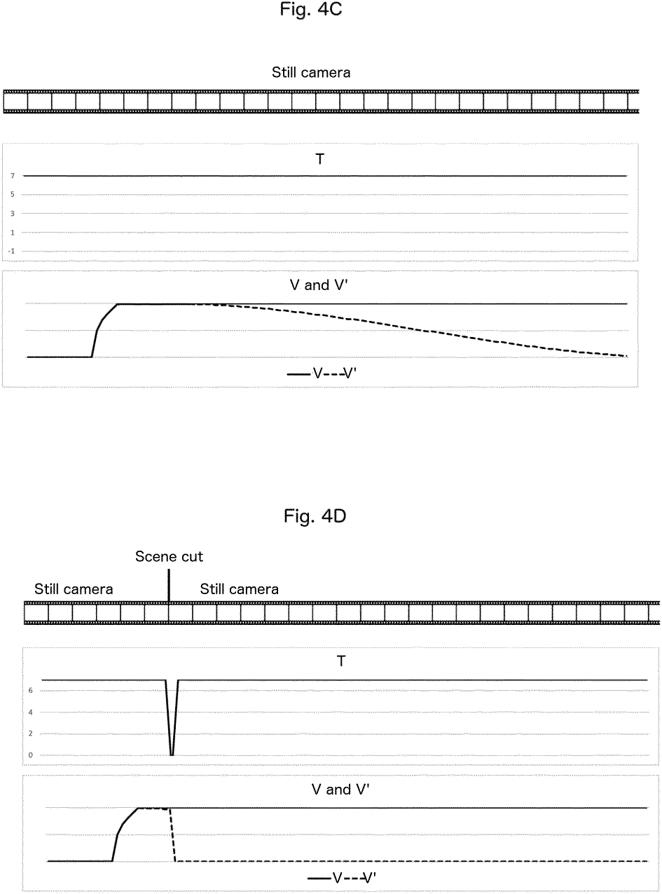

FIG. 4A shows a graph with an example of an output of the constraining filter 7 during a scene with still camera where the time window Twin (indicated on the graph as T) is constant during the scene.

In the upper graph the x-axis indicates time and the y-axis indicates seconds. In the lower graph the x-axis indicates time and the y-axis indicates angle. The solid line in the lower graph indicates the observation angle V and the dotted line indicates the output V′ of the constraining filter 7. The graph illustrates, that when there is a change in V, i.e. the eye 1 is moving, then the output V′ initially follows the change in V, and immediately thereafter follows a Smoothstep function and gradually and slowly decreased until it reaches essentially zero. Hence, the observer experiences a natural change in perspective when moving slightly and after that experiences an imperceptible or low perceptible slow camera travel back to the original perspective.

FIG. 4B shows a similar graph but where there is a fast camera movement in the video content.

In this example, Twin is also constant but smaller, hence the camera travel back to the original perspective is faster, but may still be imperceptible due to the fast camera movement in the original video content.

FIG. 4C shows a similar graph but for a scene where the camera is still and where an onset delay is comprised in the constraining function, so that there is a time interval before the decrease of V′ down to zero starts, i.e. there is a short period before after the observer’s movement and until the observer experiences that the camera starts travelling slowly back to the original perspective.

This onset delay may further reduce the perceptibility of the perceived camera movement back to the original perspective and/or reduce visually induced motion sickness because the experienced camera movement is detached from the observers movement.

FIG. 4D shows a similar graph but this time for a video sequence comprising a scene change (scene cut). Essentially at the scene cut, the controller briefly sets the time window Twin to a duration of a video frame (for example1/30^{th} of a second), hence V′ is immediately set to 0 at the time of the scene change and the perspective change is hidden by the scene change.

FIG. 5 shows a top view of an example of an alternative configuration of the disclosed invention comprising a set of eyes, wherein an eye in the set of eyes may be a left eye or a right eye of an observer in a set of N observers where N may be bigger than 1, for example 5.

The display 2 may be able to display a set of M displayable perspective view images within a time duration T where M may for example be 6 and T may be 1/60th of a second. Hence, an eye of an observer may observe a frame rate of 60 frames per second. T may be minimized to maximize the frame rate observed by an eye of an observer hence it may minimize the time interval between displaying to perspective images, which may originally be recorded essentially simultaneously. Alternatively, two perspective images may be recorded with a first time interval between them and displayed with a second time interval between them, where said first time interval and said second time interval are essentially equal.

The display 2 may further be able to display a perspective view to a subset of eyes within the set of eyes such that eyes in the set of eyes and outside the subset of eyes may not see said perspective view. Hence, each eye may essentially only see one perspective view image during an interval of duration T.

For example, the display 2 may during a first interval T1 of duration T in which all eyes are at rest display a first left eye perspective image to all left eyes and a first right eye perspective image to all right eyes. In another example, the display 2 may during a second interval T2, in which a moving left eye and a moving right eye are not at rest and the other eyes are at rest, display a first left eye perspective to left eyes at rest, a first right eye perspective to right eyes at rest, a second left eye perspective to the moving left eye and a second right eye perspective to the moving right eye. Hence, all observers can experience the desired micro movement perspective correction even if the number of eyes 2*N, in this example 2*5=10, is larger than the number of displayable perspective images M, in this example 6. In fact, in this example where M=6 and N=10 two observers may be moving while all observers are still experiencing the desired micro movement perspective correction. This is an advantage because in practical implementations of the display 2 the number M of displayable perspective views may be limited.

The display 2 may for example be a time division multiplexed display operated in duty cycles synchronized with the perspective view image generator 5, each duty cycle having a duration T and each duty cycle comprising M time slots and one of the M displayable perspective view images may be displayed during a time slot. The time interval T may be selected so the observers do essentially not experience distracting flicker, for example it may be selected to 1/60 second. Hence, the minimum frame rate Rf of the display must be Rf = M / T. In the above examples this corresponds to Rf = 6 / (1/60) = 360 fps.

The display 2 may for example be a high frame rate display, for example an LED video wall, a microLED display, an OLED display or a high frame rate projector such as the Fujitsu DynaFlash. Observers may be wearing electronic shutter glasses (not shown) comprising at least one shutter located between the eye 1 and the display 2 and where said shutter is synchronized to the display 2 such that it may be essentially open during a first time slot in which a first perspective image is displayed and essentially closed during a second time slot in which a second perspective image is displayed. Hence, the eye 1 will in the first time slot be illuminated by the display and see a perspective image displayed and in the second time slot the eye 1 will essentially not be illuminated by the display and essentially not see the perspective image displayed in the second time slot. Alternatively, it may be a display comprising directional pixels, for example a light field display or an automultiscopic display. The display may for example be automultiscopic and time division multiplexed with a duty cycle comprising at least a first time slot with light emitted in a first set of directions corresponding to a first set of eyes and a second time slot with light emitted in a second set of directions corresponding to a second set of eyes, for example a fast LCD display with a directional backlight, in a similar way to the operation described for the high frame rate display, however, instead of synchronized shutter glasses worn by observers, emission of light in a direction towards at least the eye 1 may be switched essentially on or off corresponding to the shutter in the shutter glasses being essentially open and closed. Hence, similarly to the operation with shutter glasses, the eye 1 will in the first time slot be illuminated by the display and see a perspective image displayed and in the second time slot the eye 1 will essentially not be illuminated by the display and essentially not see the perspective image displayed in the second time slot.

The eye tracking and angle detection subsystem 6 may be capable of detecting more than one eye, for example all eyes observing the display, and it may be capable of calculating V for more than one eye and to output calculated values of V synchronized with the duty cycle of the display 2 and/or with the perspective view image generator. A motion detector (not shown), for example a PID detector, may be comprised and may initialize an operation of the eye tracking and angle detection subsystem 6 when motion is detected. This may save processing time in the eye tracking and angle detection subsystem 6 and reduce latency of the perspective correction with respect to eye movements.

In an example of a configuration of the disclosed invention, the controller 9 may receive an input from the eye tracking and angle detection subsystem 6 when an observer is moving, i.e. if V″ for an eye of said observer is above Vt, and the controller 9 may direct the perspective view image generator 5 to generate perspective images according to left perspective view(V′) and right eye perspective view(V′) for said observer, and the controller 9 may identify timeslots in the duty cycle where dark images are displayed, assign a time slot number to each of the perspective images and direct the display to illuminate the left and right eye of said observer during each of the assigned time slots respectively.

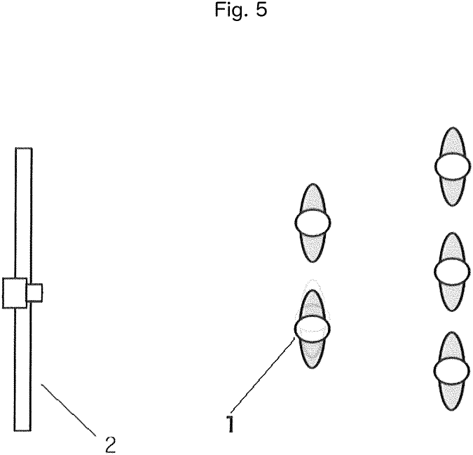

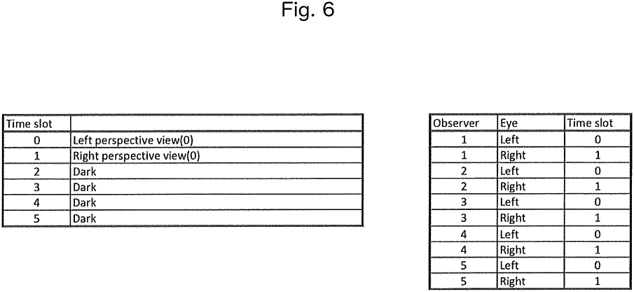

FIG. 6 shows an example of a time slot/image table and an observer/eye table in a situation when all eyes are at rest, which may further help explain the operation of the above described configuration.

The observer/eye table shows a list of eyes along with a time slot number in which the corresponding eye is illuminated by the display, i.e. the display or display controller may arrange time slot or time windows and for each time slot an image to be displayed is assigned. Some of the time slots may be reserved for dark images, i.e. reserved for the case that an observer moves and an offset image should be placed in that time slot. An offset image is an image with a perspective different from what the director of the movie intended.

As can be seen from the observer/eye table, during time slot 0 all left eyes may be illuminated by the display and during time slot 1, all right eyes may be illuminated by the display.

The time slot table/image shows a list of time slot numbers along with a description of the image displayed during the corresponding time slot.

The first entry is for time slot number 0 and the image description in the table is: “Left perspective view(0)” which indicates that a left original image with a perspective correction of 0 may be displayed during time slot 0, i.e. an original image intended for a left eye with no perspective correction may be displayed.

The second entry is for time slot number 1 and the image description in the table is: “Right perspective view(0)” which indicates that a right original image with a perspective correction of 0 may be displayed during time slot 1, i.e. an original image intended for a right eye with no perspective correction may be displayed.

During other time slots, the display may be dark.

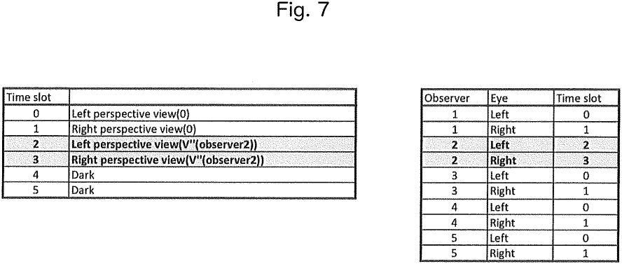

FIG. 7 shows an example of a time slot/image table and an observer/eye table in a situation when one observer, for example referred to as observer 2, is moving and all other eyes are at rest.

In this case, a left eye of observer 2 may be illuminated during time slot 2 and an image referred to as “Left perspective view(V″(observer2))”, indicating a left original perspective image corrected by V″(observer 2), may be displayed during time slot 2 and a right eye of observer 2 may be illuminated during time slot 3 and an image referred to as “Right perspective view(V″(observer2))”, indicating a right original perspective image corrected by V″(observer 2), may be displayed during time slot 3.

Hence, a left eye of observer 2 may see the “Left perspective view(V″(observer2))” image and a right eye of observer 2 may see the “Right perspective view(V″(observer2))” image. V″(observer 2) designates an angle value which may be an angle between V″ calculated for the left eye of observer 2 and V″ calculated for the right eye of observer 2.

For example, it may be calculated as the average of V″ calculated for the left eye of observer 2 and V″ calculated for the right eye of observer 2.

Alternatively, V″(observer 2) may be calculated using an angle V to a point, for example a centroid, of the head of observer 2.

Since calculation of V″ involves both limiting and high pass filtering, the difference between V″ for a right eye and V″ for a left eye of an observer may be relatively close and such approximations for V″ may be adequate. Hence, the observer 2 may see the original left and right eye perspective images perspective corrected according to her head movements.

The controller 9 may be able to dynamically adapt the duty cycle of the display 2 so that a time slot, in which the display 2 is dark, is eliminated from the duty cycle. The controller 9 may extend the duration of other time slots to maintain the duty cycle duration or it may shorten the duty cycle duration. Additionally, the controller 9 may direct the display 2 to reduce brightness intensity during a time slot, so an average brightness is essentially maintained.

Set of points
1. A method for micro movement perspective correction for a 3D display system, comprising:
   providing said 3D display system including a display screen for displaying a 3D image to an observer observing said 3D image from an observation angle,
   said observation angle defined as an angle between the line of sight between an eye of said observer and a point at said display screen,
   said 3D image being generated from a data file having a 3D scene representation including an original camera angle for displaying a right eye image to the right eye of said observer and a left eye image to the left eye of said observer,
   providing a controller and a tracking system for tracking or detecting the position of said observer,
   determining a change in said observation angle to an offset observation angle by means of said controller and tracking system,
   synthesizing a first offset 3D image from said data file and as a function of said change in said observation angle such that said original camera angle being perceived by said observer as rotated to a first synthetic camera angle,
   generating a first offset right eye image and a first offset left eye image from said first offset 3D image,
   displaying said first offset right eye image and first offset left image by means of said display screen,
   synthesizing a second offset 3D image from said data file such that said second offset 3D image having a second synthetic camera angle between said original camera angle and said first camera angle,
   generating a second offset right eye image and a second offset left eye image from said second offset 3D image,
   displaying said second offset right eye image and second offset left eye image by means of said display screen.
2. A method for a display system for updating a perspective view of a first set of images, comprising:
   providing said display system including a display screen for displaying said first set of images to said observer observing said display from an observation angle,
   providing data including said first set of images or a set of 3D models for rendering said first set of images,
   said first set of images depicting a scene from a first perspective,
   providing a controller and a tracking system for tracking or detecting an eye position of said observer,
   determining said observation angle by means of said controller and tracking system,
   generating and displaying a second set of images including a first offset image as a function of said observation angle when said observer having moved,
   each respective image of said second set of images depicting said scene from a respective perspective, each of said respective perspectives having an offset constituting an angle with respect to said first perspective.
3. The method according to any of the preceding points, synthesizing said second offset 3D image independent from the output of said tracking system.
4. The method according to any of the preceding points, said first synthetic camera angle being different from said original camera angle.
5. The method according to any of the preceding points, said first synthetic camera angle rotated with a percentage of said change in said observation angle from said original camera angle.
6. The method according to any of the preceding points, said second offset 3D image being generated after said first offset 3D image.
7. The method according to any of the preceding points, said data file constituting a motion picture or said data file comprising a sequence of 3D images.
8. The method according to any of the preceding points, comprising a filter for filtering away slow changes of the position of said observer, or synthesizing a sequence of offset 3D images as a function of time such that the synthetic camera angle for each offset 3D image gradually being rotated back towards said original camera angle.
9. The method according to any of the preceding points, defining a time window for rotating the synthetic camera angle back towards said original camera angle, said time window preferably being between 2 seconds and 15 seconds such as no more than 10 seconds and preferably 4 to 6 seconds.
10. The method according to any of the preceding points, synthesizing said second offset 3D image when said observer maintaining said offset observation angle and said original camera angle being maintained.
11. The method according to any of the preceding points, said 3D display system being an autostereoscopic display, a head mounted display such as a virtual reality headset, or said 3d display system comprising anaglyph filters.
12. The method according to any of the preceding points, defining an angle threshold such that said first synthetic camera angle being limited to angles less than said angle threshold, said angle threshold preferably being between 5 to 20 degrees such as 10 degrees,
13. The method according to any of the preceding points, said observation angle preferably having a horizontal component or said observation angle having a vertical component.
14. The method according to any of the preceding points, comprising tracking a plurality of observers observing said 3D image from a plurality of observation angles.
15. The method according to any of the preceding points, comprising providing a duty cycle controller for defining a sequence of 3D images for displaying sequentially to said plurality of observers by means of said display screen.
16. The method according to any of the preceding points, assigning a number of time windows defining a time slot for a left eye image, or a right eye image, or a dark screen in which time slot said display screen display no image or an image having reduced brightness, said time slot for a dark screen constituting an available time slot for a synthesized offset right eye image or a synthesized offset left eye image for an observer having changed observation angle.
17. A method according to any of the preceding points, said perspective defining a camera angle.
18. A method according to any of the preceding points, said camera angle defined as an angle between an observation point and a point in a scene described by said scene representation,
19. A method according to any of the preceding points, said observation angle defined as an angle between a line orthogonal to said display surface and a line between an eye position of said observer and a point at said display screen,
20. A method according to any of the preceding points comprising a change response function constituting a constraining function operating on the output of said tracking system,
   where said change response function when being input a step function initially outputs a value substantially equal to the input value and then gradually over time changes it’s output to substantially zero
21. A method according to any of the preceding points
   Where said change response function is a high pass filter
22. A method according to any of the preceding points
   Where said change response function comprises a smoothing function taking said observation angle as input and a difference function taking said observation angle and an output from said smoothing function as inputs and where an output of said change response function is set to an output of the difference function
23. A method according to any of the preceding points
   Where said smoothing function outputs a value smoothed in the time dimension
24. A method according to any of the preceding points
   Where said smoothing function is a low pass filter
25. A method according to any of the preceding points
   Where said smoothing function is selected so it has a Sigmoid like step response
26. A method according to any of the preceding points
   Where said smoothing function is selected so it has a step response substantially equal to the “Smoothstep” function, i.e. S(X) = 3X² - 2x³
27. A method according to any of the preceding points
   Where said smoothing function is selected so it has a step response substantially equal to the “Smootherstep” function, i.e. S(X) = 6x⁵ - 15X⁴ + 10X³^{.}
28. A method according to any of the preceding points
   Where said smoothing function is selected so it has a step response substantially equal to tanH or ArcTan
29. A method according to any of the preceding points
   Where said smoothing function is a derivative of a Sigmoid like function, of the SmoothStep, of the SmootherStep function, of tanH or of Arctan
30. A method according to any of the preceding points
   Where said smoothing function has a delayed response
31. A method according to any of the preceding points
   Where said smoothing function comprises a delay time constant
32. A method according to any of the preceding points
   Where a controller is comprised and where the controller is capable of determining changes in said scene and of modifying said smoothing function
33. A method according to any of the preceding points
   Where said controller is capable of determining changes in the scene by analyzing the scene representation
34. A method according to any of the preceding points
   Where said controller is capable of determining changes in the scene by analyzing meta data describing properties of the scene
35. A method according to any of the preceding points
   Where said change response function is implemented as a discrete time operation
36. A method according to any of the preceding points
   Where said discrete time operation is time synchronized to a video frame rate
37. A method according to any of the preceding points
   Where said metadata is generated substantially while the scene is displayed by said display
38. A method according to any of the preceding points
   Where said metadata is generated before the scene is displayed by said display
39. A method according to any of the preceding points
   Where said metadata is time synchronized with changes in the scene
40. A method according to any of the preceding points
   Where said metadate comprises data about changes in the scene
41. A method according to any of the preceding points
   Where said metadata comprises data about camera motion in the scene
42. A method according to any of the preceding points
   Where said metadata comprises data about scene changes (“shot detection points”) in the scene
43. A method according to any of the preceding points
   Further comprising a clamping function, where said clamping function limits said camera offset angle
44. A method according to any of the preceding points
   Where said clamping function is a Sigmoid like function
45. A method according to any of the preceding points
   Where said clamping function is a Smoothstep function, a Smootherstep function, tanH or Arctan
46. A method according to any of the preceding points
   Where said data input comprises a 3D scene model
47. A method according to any of the preceding points
   Where said data input comprises information about changes in said 3D scene model over a period of time
48. A method according to any of the preceding points
   Where said data input comprises a left eye perspective image and a right eye perspective image of the scene
49. A method according to any of the preceding points
   Where said data input comprises a multi plane image
50. A method according to any of the preceding points
   Where said data input comprises a multi plane image and said change response function is eliminated so said updated perspective view image is generated as a function of said observation angle
51. A method according to any of the preceding points
   Where said data defining a camera angle comprises a position of a virtual camera
52. A method according to any of the preceding points
   Where said data defining a camera angle comprises a perspective image of the scene recorded from said camera angle
53. A method according to any of the preceding points
   Where said data input comprises a sequence of images
54. A method according to any of the preceding points
   Where said change response function has a decay time defined as a time interval starting when a step input is being input and ending when the output is changed back to zero or to below a threshold
55. A method according to any of the preceding points
   Where said change response function is capable of performing a change in decay time to a new decay time being input from a controller
56. A method according to any of the preceding points
   Where said response function is capable of such a change in decay time substantially without abrupt changes in the output of the decay function
57. A method according to any of the preceding points
   Where an offset time is added to the input of said response function after a change in decay time so there are substantially no abrupt changes in the output of said decay function
58. A method according to any of the preceding points
   Where said controller is capable of setting the decay time of said change response function to a greater value when there is a low amount of camera motion in the scene than when there is a high amount of camera motion
59. A method according to any of the preceding points
   Where said controller is capable of setting the decay time of said change response function to a greater value when there is a low amount of object motion in the scene than when there is a high amount of object motion
60. A method according to any of the preceding points
   Where said controller is capable of directing the change response function to set it’s output to substantially zero when there is a scene cut in a sequence of images
61. A method according to any of the preceding points
   Where said controller is capable of setting the decay time of said change response function to substantially zero when there is a scene cut in a sequence of images
62. A method according to any of the preceding points
   Where said controller is capable of determining an amount of camera motion, object motion or a presence of a scene cut by analyzing the scene
63. A method according to any of the preceding points
   Where said controller is capable of determining an amount of camera motion, object motion or a presence of a scene cut by reading meta data synchronized to changes in the scene
64. A method according to any of the preceding points
   Where said camera is one of a pair of stereo cameras
65. A method according to any of the preceding points
   Where said camera is a physical camera
66. A method according to any of the preceding points
   Where said camera is a virtual camera
67. A method according to any of the preceding points
   Where said display is a 3D display
68. A method according to any of the preceding points
   Where said display is an autostereoscopic display
69. A method according to any of the preceding points
   Where said display is a head mounted display
70. A method according to any of the preceding points
   Where said display is located in a pair of VR glasses
71. A method according to any of the preceding points
   Where said display is located in a pair of AR glasses
72. A method according to any of the preceding points
   Where said data input comprises a computer file stored in a device connected to said dispay
73. A method according to any of the preceding points
   Where said data input comprises a streamed data file
74. A method according to any of the preceding points
   Where said data input comprises a live video data stream

1. A method for a display system for updating a perspective view of a first set of images, comprising:
providing said display system including a display screen for displaying said first set of images to said observer observing said display from an observation angle,
providing data including said first set of images or a light-field data set or a 3D model for rendering said first set of images, said first set of images depicting a scene from a first perspective,
providing a controller and a tracking system for tracking or detecting an eye position of said observer,
determining said observation angle by means of said controller and tracking system,
generating and displaying a second set of images including a first offset image as a function of said observation angle when said observer having moved eye position,
each respective image of said second set of images depicting said scene from a respective perspective, each of said respective perspectives having an offset constituting an angle with respect to said first perspective,
reducing said offset as a function of time such that a respective perspective is moved closer to said first perspective with time, or
setting said offset to zero at the time of a scene change.

2. The method according to any of the preceding claims, said controller and tracking system arranged for tracking a second observer, and a third observer, said second observer observing said display from a second observation angle, and said third observer observing said display from a third observation angle.

3. The method according to any of the preceding claims, determining said second observation angle and said third observation angle by means of said controller and tracking system.

4. The method according to any of the preceding claims, when said second observer and said third observer maintaining their respective positions, displaying said first set of images to said second observer and third observer.

5. The method according to any of the preceding claims, said second set of images being generating and displayed after said observer having moved eye position.

6. The method according to any of the preceding claims, said second set of images being generating and displayed with a delay with respect to said observer movement, said delay being in the range 0.5 to 6 seconds such as 1 to 2 seconds.

7. The method according to any of the preceding claims, said first set of images including a plurality of images.

8. The method according to any of the preceding claims, said first set of images including a plurality of images.

9. The method according to any of the preceding claims, said second set of images including a plurality of images.

10. The method according to any of the preceding claims, said offset being reduced by passing the output from said tracking system through a high pass filter.
